(19) United States
(12) Patent Application Publication
(10) Pub. No.: US 2023/0279184 A1
(43) Pub. Date: Sep. 7, 2023

(54) COMPOSITION COMPRISING POLYIMIDE OR PRECURSOR THEREOF, CURED PRODUCT THEREOF, POLYIMIDE FILM COMPRISING CURED PRODUCT, LAMINATE PROVIDED WITH POLYIMIDE FILM, AND DEVICE PROVIDED WITH LAMINATE

(71) Applicant: LG CHEM, LTD., Seoul (KR)

(72) Inventors: Takashi KINO, Shinagawa City, Tokyo (JP); Chan Hyo PARK, Daejeon (KR); Jinyoung PARK, Daejeon (KR); Kyunghwan KIM, Daejeon (KR); Seongku KIM, Daejeon (KR); Su Kyeong KIM, Daejeon (KR); Takashi YAMASHITA, Hachioji, Tokyo (JP)

(73) Assignee: LG CHEM, LTD., Seoul (KR)

(21) Appl. No.: 18/005,403

(22) PCT Filed: Aug. 20, 2021
(86) PCT No.: PCT/KR2021/011160

§ 371 Date: Jan. 13, 2023

(30) Foreign Application Priority Data
Aug. 21, 2020 (JP) 2020-140056

(51) Int. Cl. C08G 73/10; C08K 3/34; C08K 9/04; C08L 79/08

(52) U.S. Cl. CPC C08G 73/1067; C08G 73/1064; C08G 73/1007; C08K 3/346; C08K 9/04; C08L 79/08; C08K 2201/003; C08L 2201/08; C08L 2201/10; C08L 2203/16; C08L 2203/20

(57) ABSTRACT

A composition comprising a polyimide or a precursor thereof including a tetracarboxylic dianhydride residue and an amine residue having at least one aromatic group, and a clay mineral modified with an organic cation having at least one aromatic group, wherein the content of the clay mineral with respect to 100 parts by mass of the polyimide or a precursor thereof is more than 3.0 parts to 10 parts by mass, and wherein the cured product is colorless and transparent, or a polyimide film having a coefficient of linear expansion of 10 ppm or less, a glass transition temperature of 450° C. or more, a Yellow index of 10 or less, and a total light transmittance of 80% or more.

### TECHNICAL FIELD

The present application is a 35 U.S.C. 371 National Phase Entry Application from PCT/KR2021/011160 filed Aug. 20, 2021, which claims priority to and the benefit of Japanese Patent Application No. 2020-140056 filed in the Japan Patent Office on Aug. 21, 2020, the entire contents of which are incorporated herein by reference.

The present invention relates to a composition including a polyimide or a precursor thereof, a cured product thereof, a polyimide film including the cured product, a laminate provided with the polyimide film, and a device provided with the laminate.

### BACKGROUND OF THE INVENTION

A polyimide is a polymer material with high heat resistance, drug resistance, excellent mechanical properties, electrical properties, and dimensional stability compared to other polymer materials, and is widely used in electrical and electronic materials for automobiles, aerospace fields, flexible circuit boards, displays, adhesives, coatings, and the like.

Among these uses, with the flexibility of a display, instead of the conventional glass substrate, studies of flexible displays which uses a plastic film, especially a polyimide film as a substrate are being actively conducted.

As a representative example of a flexible display, a polyimide film for a flexible OLED display is manufactured by applying a polyimide precursor solution to a substrate such as carrier glass having a thickness of about 0.5 mm, and curing the same at about 350° C. When the difference in the coefficient of thermal expansion between the carrier glass and the polyimide film is large, only the polyimide greatly shrinks upon cooling after being cured as a polyimide, warpage occurs, and the substrate is deformed. Accordingly, the polyimide film is required to have a coefficient of thermal expansion equivalent to that of carrier glass, that is, excellent dimensional stability.

Moreover, since a substrate is treated at about 450° C. at the time of film-forming of low-temperature polysilicon in the manufacturing process of a TFT substrate of a flexible OLED display, heat resistance higher than usual is required by a polyimide film. As a material satisfying these required properties, a colored polyimide film has been conventionally used.

When a colored polyimide film is used, there exists a fault that the design of the display for mobile applications, such as a smartphone, is limited, and thus a colorless and transparent polyimide film has been required. As a way for increasing the transparency of the polyimide, it is effective to use a polyimide having a structure that does not form an intramolecular conjugate or charge transfer complex that is a cause of coloration.

Moreover, with respect to organic materials, such as a polyimide film, the method of improving steam barrier property or dimensional stability by complexing inorganic materials, such as silica or a clay mineral, is proposed.

Patent Document 1 (Japanese Patent Laid-Open Publication No. 2006-037079) discloses a colorless transparent polyimide film which has a highly improved steam barrier property and has flexibility, and proposes a composite film including an aliphatic polyimide and an organic layered silicate treated with a long-chain alkylonium ion. However, when an aliphatic polyimide and a long-chain alkylonium-modified organic layered silicate are used, there is an issue that heat resistance is insufficient and coloration occurs when the treatment is performed at a high temperature of 450° C.

Patent Document 2 (Japanese Patent Laid-Open Publication No. 2014-108994) relates to a polyimide film excellent in optical property, heat resistance, dimension stability, and thermal decomposition resistance, and proposes a polyimide prepared from an aliphatic acid dianhydride or an aromatic acid dianhydride and an aliphatic amine, and a polyimide film including organic layered silicate in which interlayer ions are exchanged with organic phosphonium ions. However, even when polyimides prepared from aliphatic acid dianhydrides or aromatic acid dianhydrides and aliphatic amines are used, heat resistance is not sufficient when treated at a high temperature of 450° C.

### BRIEF SUMMARY OF THE INVENTION

### Technical Problem

In the related art, a colorless and transparent polyimide film used as a substrate of a flexible display having excellent dimensional stability and high heat resistance after treatment at about 450° C. when forming a low-temperature polysilicon film has not been obtained. The present invention is directed to addressing an issue associated with the related art, and to providing a composition including a colorless and transparent polyimide or a precursor thereof, a cured product thereof, a polyimide film including the cured product, a laminate provided with the polyimide film, and a device provided with the laminate.

### Technical Solution

The present inventors attained the present invention, as a result of earnestly reviewing the above subject. In other words, an aspect of the present invention is achieved by a composition, which includes a polyimide or a precursor thereof including a tetracarboxylic dianhydride residue and an amine residue having at least one aromatic group, and a clay mineral modified with an organic cation having at least one aromatic group, in which the content of the clay mineral modified with the organic cation having the at least one aromatic group with respect to 100 parts by mass of the polyimide or the precursor thereof is more than 3.0 parts to 10 parts by mass, and in which the cured product is colorless and transparent.

The tetracarboxylic dianhydride used in the composition of an embodiment of the present invention preferably has at least one aromatic group.

The tetracarboxylic dianhydride used in the composition of an embodiment of the present invention is preferably at least one selected from the group consisting of pyromellitic dianhydride, biphenyltetracarboxylic dianhydride, oxydiphthalic dianhydride, naphthalenetetracarboxylic dianhydride, diphenylsulfonetetracarboxylic dianhydride, benzophenonetetracarboxylic dianhydride, and (hexafluoroisopropylidene)diphthalic dianhydride.

The amine having at least one aromatic group used in the composition of an embodiment of the present invention is preferably at least one selected from the group consisting of diaminobenzoic acid, diaminodiphenylsulfone, dimethyldiaminobiphenyl, diaminodiphenylmethane, bis(aminophenyl)sulfide, diaminobenzophenone, and bis(trifluoromethyl)benzidine.

The organic cation having at least one aromatic group used in the composition of an embodiment of the present invention is preferably represented by formula 1 below:

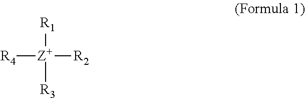

in which, Z⁺ represents a nitrogen ion, phosphorus ion, or sulfur ion; at least one of R₁ to R₄ represents an aromatic group; and among the R₁ to R₄, groups other than the aromatic group represent hydrogen or an aliphatic group having 1 to 20 carbon atoms.

In Formula 1, it is preferable that the Z⁺ is a phosphorus ion, and that the aromatic group is a phenyl group.

The clay mineral used in the composition of an embodiment of the present invention preferably has a maximum particle diameter of 200 nm or less.

In addition, another aspect of the present invention is achieved by a composition, which includes a polyimide or a precursor thereof including a tetracarboxylic dianhydride residue and diaminodiphenylsulfone, and a clay mineral modified with an organic cation having at least one aromatic group, in which the content of the clay mineral modified with the organic cation having the at least one aromatic group with respect to 100 parts by mass of the polyimide or the precursor thereof is more than 3.0 parts to 10 parts by mass.

An embodiment of the present invention also relates to a cured product of the composition of an embodiment of the present invention.

An embodiment of the present invention also relates to a polyimide film including the cured product of an embodiment of the present invention.

An embodiment of the present invention also relates to the polyimide film having a coefficient of linear expansion of 10 ppm or less, a glass transition temperature of 450° C. or more, a Yellow Index of 10 or less, and a total light transmittance of 80% or more.

In addition, an aspect of the present invention is also achieved by a polyimide film including a clay mineral modified with an organic cation having at least one aromatic group and having a coefficient of linear expansion of 10 ppm or less, a glass transition temperature of 450° C. or more, a Yellow Index of 10 or less, and a total light transmittance of 80% or more.

An embodiment of the present invention also relates to a laminate provided with the polyimide film of an embodiment of the present invention.

An embodiment of the present invention also relates to a device provided with the laminate of an embodiment of the present invention.

### Advantageous Effects

According to the composition of an embodiment of the present invention, the polyimide film including the cured product is colorless and transparent, and may have excellent dimensional stability and high heat resistance.

In addition, according to the polyimide film of an embodiment of the present invention, there may be provided the laminate or device, which is colorless and transparent, and has excellent dimensional stability and high heat resistance.

### DETAILED DESCRIPTION OF THE INVENTION

[Composition]

Hereinafter, the composition of an embodiment of the present invention will be described in detail.

The composition of an embodiment of the present invention includes a polyimide or a precursor thereof including a tetracarboxylic dianhydride residue and an amine residue having at least one aromatic group, and a clay mineral modified with an organic cation having at least one aromatic group, in which the content of the clay mineral modified with the organic cation having the at least one aromatic group with respect to 100 parts by mass of the polyimide or the precursor thereof is more than 3.0 parts to 10 parts by mass, and in which the cured product is colorless and transparent.

[Tetracarboxylic Dianhydride]

In an embodiment, the tetracarboxylic dianhydride may be selected from aromatic tetracarboxylic dianhydride and aliphatic tetracarboxylic dianhydride, and specifically may be at least one selected from the group consisting of aromatic tetracarboxylic dianhydride such as 1,2,3,4-benzenetetracarboxylic dianhydride, pyromellitic dianhydride, 2,3,3′,4′-biphenyltetracarboxylic dianhydride, 3,3′,4,4′-biphenyltetracarboxylic dianhydride, 2,2′,3,3′-biphenyltetracarboxylic dianhydride, 4,4′-oxydiphthalic anhydride, methylene-4,4′-diphthalic dianhydride, 1,2-ethylene-4,4′-diphthalic dianhydride, 2,3,6,7-naphthalenetetracarboxylic dianhydride, 1,2,5,6-naphthalenetetracarboxylic dianhydride, 1,2,4,5-naphthalenetetracarboxylic dianhydride, 1,4,5,8-naphthalenetetracarboxylic dianhydride, 3,3′,4,4′-diphenyl ether tetracarboxylic dianhydride, 3,3′,4,4′-diphenylsulfonetetracarboxylic dianhydride, 2,2′,3,3′-benzophenonetetracarboxylic dianhydride, 3,3′,4,4′-benzophenonetetracarboxylic dianhydride, and 4,4′-(hexafluoroisopropylidene)diphthalic anhydride; and aliphatic tetracarboxylic dianhydride such as ethylenetetracarboxylic dianhydride, 1,2,3,4-butanetetracarboxylic dianhydride, 1,2,3,4-cyclobutanetetracarboxylic dianhydride, 1,2,3,4-cyclopentanetetracarboxylic dianhydride, 1,2,3,4-cyclohexanetetracarboxylic dianhydride, 1,2,4,5-cyclohexanetetracarboxylic dianhydride, 3-methyl-4-cyclohexene-1,2,4,5-tetracarboxylic dianhydride, 5-(2,5- dioxotetrahydrofuryl)-3-methyl-3-cyclohexene-1,2-dicarboxylic anhydride, [1,1′-bi(cyclohexane)]-3,3′,4,4′-tetracarboxylic dianhydride, [1,1′-bi(cyclohexane)]-2,3,3′,4′-tetracarboxylic dianhydride, [1,1′-bi(cyclohexane)]-2,2′,3,3′-tetracarboxylic dianhydride, octahydropentalene-1,3,4,6-tetracarboxylic dianhydride, and bicyclo[2.2.2]octane-2,3,5,6-tetracarboxylic dianhydride.

In an embodiment, it is preferred that the tetracarboxylic dianhydride has at least one aromatic group. By having at least one aromatic group, a polyimide having high heat resistance is obtained.

In an embodiment, it is preferable that the tetracarboxylic dianhydride having at least one aromatic group is at least one selected from the group consisting of pyromellitic dianhydride, biphenyltetracarboxylic dianhydride, oxydiphthalic dianhydride, naphthalenetetracarboxylic dianhydride, diphenylsulfonetetracarboxylic dianhydride, benzophenonetetracarboxylic dianhydride, and (hexafluoroisopropylidene)diphthalic dianhydride, and specifically may be at least one selected from the group consisting of pyromellitic dianhydride, 2,3,3′,4′-biphenyltetracarboxylic dianhydride, 3,3′,4,4′-biphenyltetracarboxylic dianhydride, 2,2′,3,3′-biphenyltetracarboxylic dianhydride, 4,4′-oxydiphthalic anhydride, 2,3,6,7-naphthalenetetracarboxylic dianhydride, 1,2,5,6-naphthalenetetracarboxylic dianhydride, 1,2,4,5-naphthalenetetracarboxylic dianhydride, 1,4,5,8-naphthalenetetracarboxylic dianhydride, 3,3′,3,3′,4,4′- diphenylsulfonetetracarboxylic dianhydride, 3,3′,4,4′-benzophenonetetracarboxylic dianhydride, and 4,4′-(hexafluoroisopropylidene)diphthalic anhydride.

In an embodiment, it is preferable that the tetracarboxylic dianhydride having at least one aromatic group is at least one selected from the group consisting of pyromellitic dianhydride, biphenyltetracarboxylic dianhydride, and oxydiphthalic dianhydride, and specifically may be at least one selected from the group consisting of pyromellitic dianhydride, 2,3,3′,4′-biphenyltetracarboxylic dianhydride, 3,3′,4,4′-biphenyltetracarboxylic dianhydride, 2,2′,3,3′-biphenyltetracarboxylic dianhydride, and 4,4′-oxydiphthalic anhydride.

[Amine]

In an embodiment, it is preferable that the amine having at least one aromatic group is at least one selected from the group consisting of diaminobenzoic acid, diaminodiphenylsulfone, dimethyldiaminobiphenyl, diaminodiphenylmethane, bis(aminophenyl)sulfide, diaminobenzophenone, and bis(trifluoromethyl)benzidine. By using these amines, a colorless, transparent, and highly heat-resistant polyimide is obtained. Specifically, the amine may be at least one selected from the group consisting of 3,5-diaminobenzoic acid, 4,4′-diaminodiphenylsulfone, 3,4′-diaminodiphenylsulfone, 3,3′-diaminodiphenylsulfone, 2,2′-dimethylbiphenyl-4,4′-diamine, 4,4′-diaminodiphenylmethane, bis(4-aminophenyl)sulfide, 4,4′-diaminobenzophenone, 3,3′-diaminobenzophenone, and 2,2′-bis(trifluoromethyl)benzidine.

In an embodiment, it is preferable that the amine having at least one aromatic group is diaminodiphenylsulfone, and specifically may be at least one selected from the group consisting of 4,4′-diaminodiphenylsulfone, 3,4′-diaminodiphenylsulfone, and 3,3′-diaminodiphenylsulfone. When the amine having at least one aromatic group is diaminodiphenylsulfone, a colorless and transparent polyimide is obtained.

[Polyimide or Precursor Thereof]

In an embodiment, the preferred combinations of the tetracarboxylic dianhydride and the amine having at least one aromatic group are pyromellitic dianhydride and diaminobenzoic acid, pyromellitic dianhydride and diaminodiphenylsulfone, pyromellitic dianhydride and bis(trifluoromethyl)benzidine, biphenyltetracarboxylic dianhydride and diaminobenzoic acid, biphenyltetracarboxylic dianhydride and diaminodiphenylsulfone, biphenyltetracarboxylic dianhydride and bis(trifluoromethyl)benzidine, oxydiphthalic dianhydride and diaminobenzoic acid, oxydiphthalic dianhydride and diaminodiphenylsulfone, and oxydiphthalic dianhydride and bis(trifluoromethyl)benzidine. Particularly, the preferred combinations thereof are pyromellitic dianhydride and diaminodiphenylsulfone, biphenyltetracarboxylic dianhydride and diaminodiphenylsulfone, and oxydiphthalic dianhydride and diaminodiphenylsulfone. Thereby, a colorless and transparent polyimide having high heat resistance is obtained.

In an embodiment, the molar ratio of the total content of the tetracarboxylic dianhydride and the total content of the amine having at least one aromatic group is 1:1.5 to 1.5:1, preferably 1:1.2 to 1.2:1, more preferably 1:1.1 to 1.1:1, and most preferably 1:1 to 1:1.1 for reaction.

In an embodiment, the polymerization reaction of the tetracarboxylic dianhydride and the amine having at least one aromatic group may be carried out in a solvent. The organic solvent used may be at least one selected from the group consisting of N-dimethylformamide, N,N-dimethylacetamide, N,N-diethylpropanamide, N-methyl-2-pyrrolidone, and N-ethyl-2-pyrrolidone.

In an embodiment, the polyimide or precursor thereof may be prepared by reacting tetracarboxylic dianhydride and an amine having at least one aromatic group in a solvent. For the reaction, a conventionally known polymerization method may be used. For example, an amine having at least one aromatic group may be dissolved in a solvent, and tetracarboxylic dianhydride dissolved in the solvent may be added at a temperature of less than 100° C. for reaction to obtain a polyimide precursor. Thereafter, it may be heated to a temperature of about 350° C. for thermal imidization to obtain a polyimide.

[Organic Cation]

In an embodiment, the organic cation having at least one aromatic group is preferably represented by the formula 1 below. When the organic cation has at least one aromatic group, a composition in which a cured product has excellent dimensional stability and high heat resistance may be obtained.

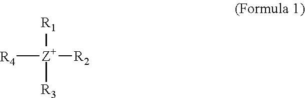

in which, Z⁺ represents a nitrogen ion, phosphorus ion, or sulfur ion; at least one of R₁ to R₄ represents an aromatic group; and among the R₁ to R₄, groups other than the aromatic group represent hydrogen or an aliphatic group having 1 to 20 carbon atoms.

In an embodiment, the aromatic group representing at least one of R₁ to R₄ may be at least one selected from the group consisting of a phenyl group, a phenylethyl group, a phenylpropyl group, a benzyl group, a benzyloxy group, a phenoxy group, a tolyl group, a xylyl group, a phenylthio group, a naphthyl group, or naphthyloxy group, or may be substituted with at least one selected from the group consisting of a hydroxyl group, a halogen atom such as a fluorine atom, a chlorine atom, a bromine atom, and an iodine atom, an alkylamino group such as a methylamino group, a dialkylamino group such as a dimethylamino group, a methoxy group, and an alkoxy group such as an ethoxy group, and a halogenated alkyl group such as a trifluoromethyl group. Preferably, the aromatic group is an unsubstituted phenyl group, a phenylethyl group, a phenylpropyl group, or a benzyl group. Especially preferably, the aromatic group is an unsubstituted phenyl group.

In an embodiment, the group represented as a group other than an aromatic group among R₁ to R₄ may be hydrogen or an aliphatic group having 1 to 20 carbon atoms, for example, may be at least one selected from the group consisting of a methyl group, an ethyl group, an n-propyl group, an isopropyl group, an n-butyl group, an s-butyl group, a t-butyl group, an n-pentyl group, an n-hexyl group, an n-heptyl group, an n-octyl group, an n-nonyl group, an n-decyl group, an n-dodecyl group, an n-hexadecyl group, an n-octadecyl group, an n-icosyl group, a cyclopropyl group, a cyclopentyl group, and a cyclohexyl group, and may be substituted with at least one selected from the group consisting of a hydroxyl group, a halogen atom such as a fluorine atom, a chlorine atom, a bromine atom, and an iodine atom, an alkylamino group such as a methylamino group, a dialkylamino group such as a dimethylamino group, a methoxy group, and an alkoxy group such as an ethoxy group, and a halogenated alkyl group such as a trifluoromethyl group.

In an embodiment, it is preferred that the Z⁺ is a phosphorus ion.

In an embodiment, it is preferable that all of R₁ to R₄ represent an aromatic group.

In an embodiment, it is preferable that the Z⁺ is a phosphorus ion, and the aromatic group is a phenyl group, and the polyimide film including a cured product may obtain a composition having excellent dimensional stability and high heat resistance. More preferably, all of R₁ to R₄ may be a phenyl group.

[Clay Mineral]

In an embodiment, the clay mineral is preferably at least one selected from the group consisting of montmorillonite, bentonite, kaolinite, mica, hectorite, hectorite fluoride, saponite, beidellite, nontronite, stevensite, vermiculite, halloysite, volkonskoite, sarconite, magadiite, and kenyaite. In an embodiment, the clay mineral may be used either natural or synthetic.

In an embodiment, the clay mineral may be untreated or treated with a known silylating agent. By addition of the silylating agent, the hydroxyl group at the terminal of the clay mineral reacts with the silylating agent to make the terminal hydrophobic. By the hydrophobization treatment, the clay mineral may be easily dispersed in a polyimide or precursor thereof to obtain a composition in which the cured product is colorless and transparent. Preferably, once a fluorinated silylating agent is selected, the obtained clay mineral is preferably fluorinated hectorite.

In an embodiment, it is preferable that the clay mineral has a maximum particle diameter of 200 nm or less, more preferably, 150 nm or less, and further more preferably, 100 nm or less. Moreover, it is preferable that the clay mineral has an average particle diameter of 150 nm or less, more preferably, 100 nm or less, and further more preferably, 50 nm or less. When the clay mineral has the above particle diameter, the composition in which the cured product is colorless and transparent may be obtained. The measurement of the particle diameter of the clay mineral is not particularly limited, but the volume particle size distribution may be measured using a laser diffraction particle size distribution measuring device, and the particle diameter (D90) in a volume particle size distribution may be made into a maximum particle diameter and the central particle diameter (D50) may be made into an average particle diameter.

In an embodiment, the content of the clay mineral modified with an organic cation having at least one aromatic group with respect to 100 parts by mass of the polyimide or precursor thereof may be more than 3.0 to 10 parts by mass. The content thereof may be preferably 3.2 parts by mass or more, more preferably 3.4 parts by mass or more, still more preferably 3.6 parts by mass or more, further preferably 3.8 parts by mass or more, most preferably 4.0% by mass or more, and preferably 8 parts by mass or less, more preferably 7 parts by mass or less, still more preferably 6 parts by mass or less, and most preferably 5 parts by mass or less. When the clay mineral falls within the above range, the composition in which the cured product has excellent dimensional stability and high heat resistance may be obtained.

In an embodiment, the clay mineral modified with an organic cation having at least one aromatic group may be obtained by ion exchange modification (intercalate) of an interlayer ion of the clay mineral with the organic cation. The method is not particularly limited, but for example, the clay mineral may be obtained by mixing 1 part by mass of the clay mineral and 0.1 to 5 parts by mass of a salt including an organic cation in at least one solvent selected from water, methanol, or ethanol, followed by filtering and drying the resulting precipitate.

In an embodiment, the cation exchange capacity (CEC) of the clay mineral modified with an organic cation having at least one aromatic group is 1 to 12 meq/100 g, preferably 3 to 10 meq/100 g, and more preferably 5 to 8 meq/100 g.

In an embodiment of the present invention, as long as the benefits of an embodiment of the present invention are not impaired, organic solvents, silane coupling agents, crosslinkable compounds, imidization catalysts for the purpose of efficiently proceeding imidization, and the like may be added. The organic solvent may be the same as or different from the organic solvent which may be included in a composition, and may be at least one selected from the group consisting of N-dimethylformamide, N,N-dimethylacetamide, N,N-diethylpropanamide, N-methyl-2-pirolidone, and N-ethyl-2-pyrrolidone.

[Cured Product]

An embodiment of the present invention also relates to a cured product of the composition of an embodiment of the present invention. The cured product of an embodiment of the present invention is colorless and transparent.

Colorless and transparent according to an embodiment of the present invention means that a 10 μm thick polyimide film obtained from a cured product has a Yellow Index of 10 or less and a total light transmittance of 80% or more. When Yellow Index and total light transmittance fall within the above range, the polyimide film optimal for a flexible OLED display may be obtained.

In an embodiment, the cured product of an embodiment of the present invention has a Yellow Index of 10 or less, preferably 8 or less, and more preferably 5 or less.

In an embodiment, the cured product of an embodiment of the present invention may have a transmittance (total light transmittance) of 80% or more, preferably 85% or more, and more preferably 90% or more for light having a wavelength of 380 to 760 nm.

In an embodiment, the cured product of an embodiment of the present invention may be prepared by adding optional components such as tetracarboxylic dianhydride, an amine having at least one aromatic group, a clay mineral modified with an organic cation having at least one aromatic group, and a solvent if necessary, and uniformly mixing, polymerization and curing reaction.

In an embodiment, the curing (imidization) reaction may select chemical imidization or thermal imidization. Chemical imidization may be imidized by heating at a temperature of 50 to 100° C. after adding a dehydrating agent and an imidization catalyst to the composition including a polyimide precursor and a clay mineral. Thermal imidization may be performed by applying a composition including a polyimide precursor and a clay mineral to a substrate such as carrier glass and then performing heat treatment at about 350° C. A preferred curing reaction is thermal imidization. A colorless and transparent cured product may be obtained by thermal imidization reaction.

In an embodiment, the imidization catalyst may be at least one selected from the group consisting of pyridine, triethylamine, picoline, quinoline, imidazole derivatives such as 1,2-dimethylimidazole, N-methylimidazole, N-benzyl-2-methylimidazole, 2-methylimidazole, 2-ethyl-4-methylimidazole, and 5-methylbenzimidazole, substituted pyridines such as isoquinoline, 3,5-dimethylpyridine, 3,4-dimethylpyridine, 2,5-dimethylpyridine, 2,4-dimethylpyridine, and 4-n-propylpyridine, and p-toluene sulfonic acid.

In an embodiment, as the dehydrating agent, an acid anhydride such as acetic anhydride may be used.

[Polyimide Film]

An embodiment of the present invention also relates to a polyimide film including the cured product of an embodiment of the present invention.

In an embodiment, the polyimide film may be obtained by applying a uniform film of the composition including a polyimide precursor and a clay mineral to a substrate such as carrier glass in the process of curing (imidizing) the composition, and then curing the composition by heating at about 350° C.

In an embodiment, in consideration of the applicability during a polyimide film-forming process, it is preferable that the composition includes solid content in an amount having an appropriate viscosity. The content of the clay mineral modified with an organic cation having at least one aromatic group, an amine having at least one aromatic group, and tetracarboxylic dianhydride may be adjusted so that the content of the composition becomes 10 to 40% by mass, preferably 20 to 30% by mass.

In an embodiment, the viscosity of the composition upon application to the substrate may be 1000 mPa·s or more, preferably 3,000 mPa·s or more, more preferably 4,000 mPa·s or more, and 10,000 mPa·s or less, preferably may be 9,000 mPa·s or less, and more preferably 8,000 mPa·s or less. When the viscosity of the composition exceeds 10,000 mPa·s, the defoaming property decreases during processing of the polyimide film, so that not only the efficiency in the process but also the surface roughness of the produced film becomes poor due to the generation of air bubbles. Accordingly, electrical, optical, and mechanical properties deteriorate.

In an embodiment, the polyimide precursor included in the composition may have a weight average molecular weight of 10,000 to 200,000 g/mol, preferably 20,000 to 100,000 g/mol, and more preferably 30,000 to 100,000 g/mol. Moreover, the molecular weight distribution (Mw/Mn) of the polyimide precursor may be 1.1 to 4.0, preferably 1.1 to 3.0, and more preferably 1.1 to 2.5. When the weight average molecular weight or molecular weight distribution of the polyimide precursor is outside of the above range, there is a fear that the film formation is difficult or the properties of the polyimide film such as transmittance, heat resistance, and mechanical properties may deteriorate. Although the measurement of molecular weight is not particularly limited, gel permeation chromatography may be used, and the weight average molecular weight and molecular weight distribution of the polyimide precursor may be computed from the calibration curve of a polystyrene standard.

In an embodiment, the thickness of the polyimide film may be 5 to 20 μm, preferably 8 to 15 μm, and more preferably 10 to 12 μm.

In an embodiment, the polyimide film of an embodiment of the present invention preferably has a coefficient of linear expansion of 10 ppm or less, a glass transition temperature of 450° C. or more, a Yellow Index of 10 or less, and a total light transmittance of 80% or more.

An embodiment of the present invention also relates to a polyimide film including a clay mineral modified with an organic cation having at least one aromatic group and having a coefficient of linear expansion of 10 ppm or less, a glass transition temperature of 450° C. or more, a Yellow Index of 10 or less, and a total light transmittance of 80% or more.

The 10 μm-thick polyimide film of an embodiment of the present invention may have a coefficient of linear expansion of 10 ppm/° C. or less, preferably 9 ppm/° C. or less, and more preferably 8 ppm/° C. or less after heating and cooling processes in a temperature range of 100 to 400° C. When the coefficient of linear expansion of the polyimide film is 10 ppm/° C., excellent dimensional stability is obtained.

The polyimide film of an embodiment of the present invention may have a glass transition temperature of 450° C. or higher, preferably 460° C. or more, and more preferably 470° C. or more. When the glass transition temperature of a polyimide film is 450° C. or more, high heat resistance is obtained.

The coefficient of linear expansion and the glass transition temperature are not particularly limited, and may be measured by thermomechanical analysis (TMA).

[Laminate]

An embodiment of the present invention also relates to a laminate provided with the polyimide film of an embodiment of the present invention.

In an embodiment, the laminate of an embodiment of the present invention provides a laminate including a substrate such as carrier glass and a metal, and a polyimide film, which is a cured product of the composition and is formed on the surface of the substrate.

An embodiment of the present invention also relates to a device provided with the laminate of an embodiment of the present invention.

In an embodiment, the laminate of an embodiment of the present invention is used for manufacturing a flexible device, a semiconductor device is formed on a polyimide film, and then the support is peeled off to obtain the flexible device with the flexible transparent laminate which is configured of a polyimide film. Examples of flexible devices include a flexible display, a flexible solar cell, a flexible touch panel electrode substrate, flexible lighting, a flexible battery, and the like.

In an embodiment, when the laminate of an embodiment of the present invention forms a flexible OLED display, the polyimide film of an embodiment of the present invention is formed thereon with carrier glass as a substrate. Thereafter, through various processes, TFT or the like is formed on a polyimide film, and a glass substrate is finally removed through a LASER-LIFT-OFF (LLO) process. The process of forming the TFT on a polyimide film generally uses an inorganic material, and a TFT-IGZO (InGaZnO) oxide semiconductor is formed at about 350° C. or a TFT (a-S-TFT, poly-Si-TFT) semiconductor is formed at about 450° C. Since the polyimide film of an embodiment of the present invention has the excellent dimensional stability and high heat resistance, it is suitable also for formation of a TFT (a-S-TFT, poly-Si-TFT) semiconductor at 450° C.

Hereinafter, the present invention will be described with reference to the examples, but the present invention is not limited thereto.

### Synthesis Example 1

3 g of tetraphenylphosphonium bromide was dissolved in 100 ml of a mixture of methanol:water=1: 1, 10 g of a clay mineral (Smecton SWF manufactured by Kunimine Co., Ltd.) was added dropwise to an aqueous solution of 500 ml dissolved therein, and the precipitate was recovered and dried to obtain a clay mineral modified with tetraphenylphosphonium ions having an average particle diameter of 50 nm. Hereinafter, the obtained clay mineral is referred to as TPP-SWF.

### Example 1

Nitrogen was introduced into a 1 L glass reactor and flow continued for a certain period of time, and then 800 g of N-methyl-2-pyrrolidone (NMP) was added and stirring was started. Next, 4,4′-diaminodiphenylsulfone (4,4DDS) was added, and stirring was continued until complete dissolution. Thereafter, sBPDA was added in a molar ratio of 3,3′,4,4′-biphenyltetracarboxylic dianhydride (sBPDA)/4,4DDS=1.005, the temperature was raised to 50° C., and stirring was continued. Finally, the solution of the polyamic acid (precursor of polyimide) whose solid content concentration is 20% by mass and a viscosity is 5,000 mPa·s was obtained.

Four parts by mass of TPP-SWF was added to the NMP solution of polyamic acid with respect to 100 parts by mass of polyamic acid, and stirred while irradiating ultrasonic waves at a temperature of 50° C. to disperse TPP-SWF.

A solution of polyamic acid in which TPP-SWF was dispersed was applied to a 0.5 mmt alkali-free glass plate (EAGLE XG, manufactured by Corning). After drying at 50° C. for 30 minutes in a nitrogen oven adjusted to an oxygen concentration of 20 ppm or less (nitrogen oven manufactured by Koyo Thermo Systems), it was sintered at 100° C. for 30 minutes, 150° C. for 30 minutes, 200° C. for 30 minutes, 250° C. for 30 minutes, 300° C. for 30 minutes, and 350° C. for 30 minutes, and prepared the polyimide film with a thickness of 10 μm on an alkali free glass. The obtained polyimide film was removed from the glass substrate, and the property was evaluated.

(Examples 2 to 5 and Comparative Examples 1 to 27)

Examples 2 to 5 and Comparative Examples 1 to 27 prepared polyimide films in the same manner as in Example 1 except that the raw material and composition ratio of the composition were changed as described in Tables 1 and 2 below. The raw materials described in the table are as follows.
sBPDA: 3,3′,4,4′-biphenyltetracarboxylic dianhydride
PMDA: Pyromellitic dianhydride
ODPA: Oxydiphthalic dianhydride
4,4DDS: 4,4′-diaminodiphenylsulfone
3,4DDS: 3,4′-diaminodiphenylsulfone
3,3DDS: 3,3′-diaminodiphenylsulfone
4,4ODA: 4,4′-oxydianiline

TABLE 1

| | | | | | | | Composition | |
|---|---|---|---|---|---|---|---|---|
| | | | | | | | Polyimide or | |
| | Polyimide or Precursor Thereof | | | | | | Precursor | |
| Ex. | sBPDA | PMDA | ODPA | 4,4DDS | 3,4DDS | 3,4DDS | Thereof | TPP-SWF |
| Unit | Mole | | | | | | Parts by mass | |
| 1 | 100 | | | 100 | | | 100 | 4 |
| 2 | | 100 | | 100 | | | 100 | 4 |
| 3 | | | 100 | 100 | | | 100 | 4 |
| 4 | 100 | | | | 100 | | 100 | 4 |
| 5 | 100 | | | | | 100 | 100 | 4 |

TABLE 2

| | | | | | | | | Composition | |
|---|---|---|---|---|---|---|---|---|---|
| | | | | | | | | Polyimide or | |
| | Polyimide or Precursor Thereof | | | | | | | Precursor | |
| Com. Ex. | sBPDA | | | | | | | Thereof | TPP-SWF |
| Unit | Mole | PMDA | ODPA | 4,4DDS | 3,4DDS | 3,4DDS | 4,4ODA | Parts by mass | |
| 1 | 100 | | | 100 | | | | 100 | 1 |
| 2 | 100 | | | 100 | | | | 100 | 2 |
| 3 | 100 | | | 100 | | | | 100 | 3 |
| 4 | | 100 | | 100 | | | | 100 | 1 |
| 5 | | 100 | | 100 | | | | 100 | 2 |
| 6 | | 100 | | 100 | | | | 100 | 3 |
| 7 | | | 100 | 100 | | | | 100 | 1 |
| 8 | | | 100 | 100 | | | | 100 | 2 |
| 9 | | | 100 | 100 | | | | 100 | 3 |
| 10 | 100 | | | | 100 | | | 100 | 1 |
| 11 | 100 | | | | 100 | | | 100 | 2 |
| 12 | 100 | | | | 100 | | | 100 | 3 |
| 13 | 100 | | | | | 100 | | 100 | 1 |
| 14 | 100 | | | | | 100 | | 100 | 2 |
| 15 | 100 | | | | | 100 | | 100 | 3 |
| 16 | 100 | | | | | | 100 | 100 | 1 |
| 17 | 100 | | | | | | 100 | 100 | 2 |
| 18 | 100 | | | | | | 100 | 100 | 3 |
| 19 | 100 | | | | | | 100 | 100 | 4 |
| 20 | | 100 | | | | | 100 | 100 | 1 |
| 21 | | 100 | | | | | 100 | 100 | 2 |
| 22 | | 100 | | | | | 100 | 100 | 3 |
| 23 | | 100 | | | | | 100 | 100 | 4 |
| 24 | | | 100 | | | | 100 | 100 | 1 |
| 25 | | | 100 | | | | 100 | 100 | 2 |
| 26 | | | 100 | | | | 100 | 100 | 3 |
| 27 | | | 100 | | | | 100 | 100 | 4 |

(Evaluation of physical properties of polyimide film) Yellow Index, total light transmittance, coefficient of linear expansion (CTE), and glass transition temperature (Tg) of the obtained polyimide films of Examples 1 to 5 and Comparative Examples 1 to 27 were measured by the method below. The results thereof are described in Table 3 and Table 4.

(Measurement of Yellow Index)

After sintering for 10 minutes with an oxygen concentration of 20 ppm or less at 450° C. under nitrogen atmosphere, the Yellow Index (YI) of the polyimide film cooled to room temperature was measured using Color Eye 7000A.

(Measurement of Total Light Transmittance)

After sintering for 10 minutes with an oxygen concentration of 20 ppm or less at 450° C. under nitrogen atmosphere, the total light transmittance of the polyimide film cooled to room temperature was measured by a method according to ASTM D1003 using a Haze Meter HM-150.

(Measurement of Coefficient of Linear Expansion and Glass Transition Temperature)

The polyimide film was cut into a size of 5×20 mm to prepare a sample, and then the sample was loaded using an accessory. The length of the film actually measured was 16 mm. The tension of the film was set to 0.02 N, and a primary temperature increase process at a temperature increase rate of 5° C./min in a temperature range of 100 to 400° C. was performed. Then, the coefficient of linear expansion when cooled at a cooling rate of 4° C./min in a temperature range of 400 to 100° C. was measured using a thermomechanical analysis (TMA) apparatus (Q400 manufactured by TA). Thereafter, a secondary temperature increase process was performed again at a temperature increase rate of 5° C./min in a temperature range of 100 to 450° C. The inflection point seen in the temperature increase section was made into Tg of the polyimide film. When no inflection point was detected, the Tg of the film was determined to be greater than 450° C.

TABLE 3

| | | Transmittance | CTE | Tg |
|---|---|---|---|---|
| Examples | YI | (%) | (ppm) | (° C.) |
| 1 | 9 | 87 | 3 | Greater than 450 |
| 2 | 9 | 87 | 3 | Greater than 450 |
| 3 | 9 | 87 | 10 | Greater than 450 |
| 4 | 9 | 87 | 3 | Greater than 450 |
| 5 | 9 | 87 | 3 | Greater than 450 |

TABLE 4

| Comparative | | Transmittance | CTE | Tg |
|---|---|---|---|---|
| Examples | YI | (%) | (ppm) | (° C.) |
| 1 | 3 | 90 | 60 | 350 |
| 2 | 5 | 89 | 40 | 350 |
| 3 | 7 | 88 | 20 | 350 |
| 4 | 3 | 90 | 60 | 350 |
| 5 | 5 | 89 | 40 | 350 |
| 6 | 7 | 88 | 20 | 350 |
| 7 | 3 | 90 | 100 | 300 |
| 8 | 5 | 89 | 70 | 300 |
| 9 | 7 | 88 | 30 | 300 |
| 10 | 3 | 90 | 60 | 350 |
| 11 | 5 | 89 | 40 | 350 |
| 12 | 7 | 88 | 20 | 350 |
| 13 | 3 | 90 | 60 | 350 |
| 14 | 5 | 89 | 40 | 350 |
| 15 | 7 | 88 | 20 | 350 |
| 16 | 20 | 10 | 100 | 260 |
| 17 | 20 | 10 | 70 | 260 |
| 18 | 20 | 10 | 30 | 260 |
| 19 | 20 | 10 | 3 | Greater than 450 |
| 20 | 20 | 10 | 40 | 340 |
| 21 | 20 | 10 | 25 | 340 |
| 22 | 20 | 10 | 10 | 340 |
| 23 | 20 | 10 | 3 | Greater than 450 |
| 24 | 20 | 10 | 100 | 350 |
| 25 | 20 | 10 | 70 | 350 |
| 26 | 20 | 10 | 30 | 350 |
| 27 | 20 | 10 | 3 | Greater than 450 |

Comparative Examples 1 to 3, 4 to 6, 7 to 9, 10 to 12, and 13 to 15 show the results of polyimide films prepared by blending TPP-SWF in a composition in a small content with respect to Examples 1, 2, 3, 4, and 5, respectively. In Comparative Examples 1 to 15, a polyimide film having a sufficient coefficient of linear expansion and heat resistance was not obtained. Comparative Examples 16 to 19 show the results of polyimide films each prepared by blending 1 to 4 parts by mass of TPP-SWF with a polyimide precursor of sBPDA/4,4ODA. Comparative Examples 20 to 23 show the results of polyimide films each prepared by blending 1 to 4 parts by mass of TPP-SWF with a polyimide precursor of PMDA/4,4ODA. Comparative Examples 24 to 27 show the results of polyimide films each prepared by blending 1 to 4 parts by mass of TPP-SWF with a polyimide precursor of ODPA/4,4ODA. Since any polyimide film had high YI and low total light transmittance, it could not be used as a colorless and transparent base material.

In Examples 1 to 5, since YI was low and the total light transmittance was high, a colorless and transparent polyimide film having an excellent coefficient of linear expansion and high heat resistance was obtained.

### INDUSTRIAL APPLICABILITY

The polyimide film of an embodiment of the present invention has no restrictions other than those described above, and may be used as a substrate for flexible OLED displays and the like. From its excellent coefficient of linear expansion and high heat resistance, the polyimide film is also suitable for use in TFT (a-S-TFT, poly-Si-TFT) semiconductor formation at 450° C. In addition, since the polyimide film of an embodiment of the present invention is colorless and transparent, it can be used in displays for mobile applications such as smartphones without design limitation.

1. A composition comprising:
a polyimide or a precursor thereof including a tetracarboxylic dianhydride residue and an amine residue having at least one aromatic group, and
a clay mineral modified with an organic cation having at least one aromatic group,
wherein a content of the clay mineral modified with the organic cation having the at least one aromatic group is more than 3.0 parts to 10 parts by mass with respect to 100 parts by mass of the polyimide or the precursor thereof, and
wherein a cured product of the composition is colorless and transparent.

2. The composition of claim 1, wherein the tetracarboxylic dianhydride residue has at least one aromatic group.

3. The composition of claim 1, wherein the tetracarboxylic dianhydride of the tetracarboxylic dianhydride residue is at least one selected from the group consisting of pyromellitic dianhydride, biphenyltetracarboxylic dianhydride, oxydiphthalic dianhydride, naphthalenetetracarboxylic dianhydride, diphenylsulfonetetracarboxylic dianhydride, benzophenonetetracarboxylic dianhydride, and (hexafluoroisopropylidene)diphthalic dianhydride.

4. The composition of claim 1, wherein the amine residue having at least one aromatic group is at least one selected from the group consisting of diaminobenzoic acid, diaminodiphenylsulfone, dimethyldiaminobiphenyl, diaminodiphenylmethane, bis(aminophenyl)sulfide, diaminobenzophenone, and bis(trifluoromethyl)benzidine.

5. The composition of claim 1, wherein the organic cation having at least one aromatic group in the clay mineral is represented by formula 1 below: 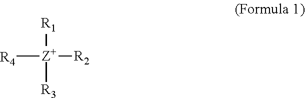
wherein, Z⁺ represents a nitrogen ion, phosphorus ion, or sulfur ion; at least one of R₁ to R₄ represents an aromatic group; and among the R₁ to R₄, groups other than the aromatic group represent hydrogen or an aliphatic group having 1 to 20 carbon atoms.

6. The composition of claim 5, wherein the Z⁺ is a phosphorus ion, and the aromatic group is a phenyl group.

7. The composition of claim 1, wherein the clay mineral has a maximum particle diameter of 200 nm or less.

8. A cured product of the composition according to claim 1.

9. A polyimide film including the cured product according to claim 8.

10. The polyimide film of claim 9, wherein the polyimide film has a coefficient of linear expansion of 10 ppm or less, a glass transition temperature of 450° C. or more, a Yellow Index of 10 or less, and a total light transmittance of 80% or more.

11. A polyimide film including a clay mineral modified with an organic cation having at least one aromatic group and having a coefficient of linear expansion of 10 ppm or less, a glass transition temperature of 450° C. or more, a Yellow Index of 10 or less, and a total light transmittance of 80% or more.

12. A laminate comprising the polyimide film according to claim 9.

13. A device comprising the laminate according to claim 12.

14. A laminate comprising the polyimide film according to claim 11.

15. A device comprising the laminate according to claim 14.
